(19) United States
(12) Patent Application Publication
(10) Pub. No.: US 2024/0292188 A1
(43) Pub. Date: Aug. 29, 2024

(54) MULTIMODAL INDOOR POSITIONING SYSTEMS AND METHODS FOR PRIVACY LOCALIZATION

(71) Applicant: UNIVERSITY OF LOUISIANA LAFAYETTE, Lafayette, LA (US)

(72) Inventors: Raju GOTTUMUKKALA, Lafayette, LA (US); Azmyin Md. KAMAL, Lafayette, LA (US); Seyedmajid HOSSEINI, Lafayatte, LA (US)

(73) Assignee: UNIVERSITY OF LOUISIANA LAFAYETTE, Lafayette, LA (US)

(21) Appl. No.: 18/585,467

(22) Filed: Feb. 23, 2024

Related U.S. Application Data
(60) Provisional application No. 63/448,069, filed on Feb. 24, 2023.

(51) Int. Cl. H04W 4/029; G01S 1/02; G01S 5/02; G06T 7/70; G06V 10/82; H04B 17/318; H04W 4/33

(52) U.S. Cl. CPC H04W 4/029; G01S 1/02; G01S 5/0252; G06T 7/70; G06V 10/82; H04B 17/318; H04W 4/33; G06V 2201/07

(57) ABSTRACT

Disclosed herein are multimodal indoor positioning systems and methods that include: one or more Bluetooth low energy beacons; one or more smartphones, where the smartphone captures one or more Bluetooth low energy signals from the one or more Bluetooth low energy beacons, where the smartphone generates a fingerprint and a location estimate from the relative signal strength indicator signal; one or more cameras, where the one or more cameras capture 2D video frames; and one or more edge devices, where the one or more edge devices receive the fingerprint and the location estimate from the one or more smartphones, where the one or more edge devices receive the 2D video frames from the one or more cameras, where the edge device generates 2D position coordinates from the 2D video frames; and where the one or more edge devices assigns a tracklet-ID to each smartphone in the 2D video frames.

### BACKGROUND

### Field

Provided herein are multimodal indoor positioning systems (MIPS) and methods that can uniquely distinguish between users and provide accurate location-based information using sensory data obtained from the surrounding environment.

### Description of the Related Art

Intelligent building environments aim to provide location-based services for people that have real-world applications such as assistive technologies for disabled people, patient tracking in hospitals, smart homes [1], smart advertisement in retail stores [2], augmented reality [3], tracking proximity during pandemics [4] and so on. These location-based services are dependent on indoor positioning technology. There is a wide range of commercially available technologies for indoor localization, and the choice of technology depends on the specific use case and requirements, such as online vs. offline, cost-effectiveness, accuracy, privacy, and flexibility. For example, commercial high precision tracking systems, such as Ubisense 7000, BeSpon, and EVK1000, provide centimeter range precision with high accuracy [5] but are expensive and require users to carry a tag or device. Smartphones are the most preferred choice because localizing and tracking mobile phones is analogous to tracking the users [6]. Using smartphones as tracking devices have additional advantages, such as anonymization and establishing a communication channel with users. For example, during the COVID-19 pandemic, identifying physical proximity and communicating with people was also important, and several countries adopted smartphone-based BLE for privacy-aware physical proximity sensing [7].

Fingerprinting the Received Signal Strength Indicator (RSSI) from Bluetooth Low Energy (BLE) or Wi-Fi is a common approach for indoor localization [8]. Many researchers have studied this idea extensively using statistical and machine learning approaches [9]. The main limitations of using RSSI signal is that the signal is prone to interference and noise, and prior studies have shown that RSSI-based localization has been shown to perform well within a resolution of 1 to 3 meters, but the performance of localization becomes abysmal below 1 meter.

State-of-the-art real-time locating systems (RTLS) use technologies such as ultra-wideband (UWB) for localization and tracking that provide positioning accuracy precision of less than one meter [12], [13]. Both Kalman Filter based [15] and deep learning-based approaches [16], [17] have been used for matching identifiers generated from multiple modalities. The Kalman filter-based multi-modal localization had a localization error of 1.5 m. The deep learning approaches achieved an accuracy of 81% for real-time object mapping. Recent work uses deep neural network-based RSSI fingerprinting to achieve better performance [18], [19], for instance, achieving 0.75 m localization error or 80% of error under one meter, but these approaches were tested with a single robot over a wide area. Multi-modal fusion has been applied for various indoor tracking technologies. Mobile robots use computer vision to detect and track people [20] using facial features from images and stereo vision. Wang et al. [21] fused Wi-Fi and BLE signals with Bayesian filtering and simulated annealing to slightly improve Wi-Fi-based localization. Papaioannou et al. used Hidden Markov Models and conditional random fields to resolve motion ambiguities when combining multiple nonoverlapping cameras with radio and inertial data to track humans at construction sites [22]. Ksiaz⋅ek et al. used distance based location aggregates generated from GPS, WLAN, and BLE to generate better trajectories [23]. Xu et al. integrated video, radio signals, and gait information [11]. In recent work [24], experimentation and simulation studies were conducted to use distance-based similarity metrics to fuse wireless signals from Wi-Fi with computer vision, which improved localization performance [25] used the images from cameras and the motion trajectories like an accelerometer and gyroscope from mobile devices to map trajectories from the users based on location proximity and a Bayesian distribution. Table 1 section provides a summary of state-of-the-art indoor positioning and localization models.

TABLE 1
Current indoor positioning and localization models

| | | | | Granularity | Average |
|---|---|---|---|---|---|
| Author | Multi-modal sensors | Method | Accuracy | (m) | time (s) |
| Xu et al. | Multiple surveillance | Mask R-CNN | 70 | 0.7 | 0.32 |
| [11] | cameras, IMU, | | | | |
| | Wireless signal | | | | |
| Shu et al. | WiFi, Gyro, Acc | EPF | 99.4 | 6.58 | N/A |
| [26] | | | | | |
| CAO, Wang | Multiple surveillance | Multilevel | 90 | 0.65 | 3 |
| [27] | cameras, Acc | decision | | | |
| Li et al. | Kinect, RFID | SVM | 93.3 | N/A | 7 |
| [28] | | | | | |
| Henschel | Surveillance camera, | BLP | 91.2 | N/A | N/A |
| [29] | Acc | | | | |
| Jung et al. | Surveillance camera, | Leaf | 82 | N/A | 0.2 |
| [11] | Acc | Clustering | | | |
| Liu et al. | Video, WiFi, IMU | multi-modal | 81 | N/A | 0.36 |
| [15] | | RNN | | | |
| Papaioannou | GPS, WLAN, and BLE | PDF | N/A | 3 | N/A |
| [30] | | | | | |
| ksikazek | Camera, radio, inertial | Adaptive | N/A | 2 | 60 |
| [23] | sensors | learning | | | |
| zhu | WiFi, video | CNN | 90 | 2 | N/A |
| [24] | | | | | |
| Zhai | Multiple cameras, IMU | VM fusion | N/A | 0.44 | 0.48 |
| [25] | | | | | |
| MIPS | Overhead camera, BLE | Siamese | 95.16 | 0.40 | 0.23 |
| (Inventive | | Networks | | | |
| Approach) | | | | | |

In addition, Siamese networks have been applied for similarity mapping problems in domains that have noisy and potentially unseen signals such as multi-camera computer vision [31]-[33], text matching [34], [35], and signal patterns [36]. However, these systems can have drawbacks. For example, systems that need to store of digital profiles can lead to privacy concerns or systems that use RSSI-based fingerprinting technologies can have an accuracy from 1 meter to 3 meters, but perform poorly at less than 1 meter.

Consequently, there is a need for new indoor positioning systems that can increase the performance of localizing and tracking users and eliminate the need to store digital profiles.

### SUMMARY

Disclosed herein are multimodal indoor positioning systems and methods that can increase the performance of localizing and tracking users and eliminate the need to store digital profiles. In a specific embodiment, the multimodal indoor positioning system can include: one or more Bluetooth low energy beacons; one or more smartphones, where the smartphone captures one or more Bluetooth low energy signals from the one or more Bluetooth low energy beacons, where the one or more Bluetooth low energy signals includes a relative signal strength indicator signal, where the smartphone generates a fingerprint and a location estimate from the relative signal strength indicator signal; one or more cameras, where the one or more cameras capture 2D video frames; and one or more edge devices, where the one or more edge devices are in electronic communication with the one or more cameras, where the one or more edge devices are in electronic communication with the one or more smartphones, where the one or more edge devices are in electronic communication with the one or more Bluetooth low energy beacons, where the one or more edge devices receive the fingerprint and the location estimate from the one or more smartphones, where the one or more edge devices receive the 2D video frames from the one or more cameras, where the edge device generates 2D position coordinates from the 2D video frames; and where the one or more edge devices assigns a tracklet-ID to each smartphone in the 2D video frames.

In another specific embodiment, the multimodal indoor positioning system can include: a non-transitory computer readable medium comprising instructions which, when implemented by one or more computers, causes the one or more computers to: receive a Bluetooth low energy signal from Bluetooth low energy beacon, where the Bluetooth low energy signal includes a relative signal strength indicator signal; generate a fingerprint and a location estimate from the relative signal strength indicator signal; capture 2D video frames from the one or more cameras; generate tracklet IDs and 2D coordinates for one or more people in the 2D video frames; and display the fingerprint and the location estimate.

### BRIEF DESCRIPTION OF THE DRAWINGS

For the purposes of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art can utilize their teachings. Therefore, no limitation of the scope of the present disclosure is thereby intended.

FIG. 1 is a drawing of an embodiment of the multimodal indoor positioning system.

FIG. 2 is a drawing of an embodiment of the multimodal indoor positioning system.

FIG. 3 shows a workflow for an embodiment of a multimodal indoor positioning system.

FIG. 4 is a drawing of an embodiment of a Siamese Network.

FIGS. 5A-5B is a picture of actual study area and a grid representation of study area.

FIG. 6 shows an overhead camera step up for an embodiment of a multimodal indoor positioning system.

FIGS. 7A-7E show paths taken by users in each scenario, each color representing a different user with triangles depicting the starting point of each user.

FIGS. 8A-8B shows the object localization accuracy of BLE-IPS and MIPS for various scenarios.

FIG. 9 shows the object localization accuracy over time for scenario 5.

FIGS. 10A-10B show the object localization error of BLE-IPS and MIPS for various scenarios.

FIGS. 11A-11D show object localization accuracy for different historical time periods under consideration.

FIGS. 12A-12D show object of localization error of various techniques for different window sizes.

FIG. 13 shows an embodiment a Hungarian algorithm.

FIG. 14 shows an embodiment a Mapping algorithm.

FIG. 15 shows an embodiment a Tracking algorithm.

### DETAILED DESCRIPTION

Indoor Positioning and Localization are essential to provide location-based services in smart building environments. The choice of indoor position technology is usually a tradeoff between various factors such as cost, localization performance, and privacy. The general idea of multi-modal localization is to combine more than one modality to provide better localization performance. Provided herein are multimodal approaches that combines BLE and computer vision techniques with the goal to track mobile phones anonymously.

In one or more embodiments, the multimodal indoor position systems and methods can include, but are not limited to: one or more computers, one or more memories, one or more central processor units, one or more edge devices, one or more smartphones, one or more computer applications, one or more computer networks, one or more Bluetooth-enabled mobile devices, one or more receivers, one or more transmitters, one or more Bluetooth beacons, one or more cameras, and one or more sensors.

The one or more edge devices can include, but are not limited to: one or more routers, one or more routing switches, one or more integrated access devices (IADs), one or more multiplexers, one or more metropolitan area networks (MAN), and one or more wide area network (WAN) access devices. Edge devices also provide connections into carrier and service provider networks. An edge device that connects a local area network to a high speed switch or backbone (such as an ATM switch) may be called an edge concentrator. In an embodiment, the multimodal indoor position system can use radio signal-based technologies such as Ultra-wideband (UWB), Wi-Fi, Bluetooth low energy, radio frequency identification (RFID), and combination thereof.

The one or more edge devices can include, but are not limited to: one or more routers, one or more routing switches, one or more Bluetooth low energy transceivers, one or more integrated access devices (IADs), one or more multiplexers, one or more metropolitan area networks (MAN), and one or more wide area network (WAN) access devices. Edge devices also provide connections into carrier and service provider networks. An edge device that connects a local area network to a high speed switch or backbone (such as an ATM switch) may be called an edge concentrator. In an embodiment, the multimodal indoor position system can use radio signal-based technologies such as Ultra-wideband (UWB), Wi-Fi, Bluetooth low energy, radio frequency identification (RFID), and combination thereof.

The multi-modal method used to aggregate location estimates from BLE and overhead cameras was demonstrated. The multi-modal method to localization draws inspiration from prior literature on multimodal localization using radio signals like Wi-Fi, accelerometer, or gyroscope data with video information from cameras to track individuals in an indoor space better [10], [11]. Locations were extracted from an overhead camera system that uses computer vision-based object detection. The multimodal indoor positioning systems and methods does not track the users' facial features, gestures, or skeletal features and only extracts the location from the object's bounding box. The computer vision system generates new object identifiers every time the user leaves and enters the scene. One of the key privacy-preserving features of the system is that it only tracks the anonymous mobile device identifier generated by the mobile device while the user is in the scene. The multimodal approach uses independent trajectories from BLE and camera, and the trajectory mapping function is learned through a Siamese network.

Here, a multi-modal approach based on a Siamese network that combines the location trajectories extracted from two signals, i.e., BLE and computer vision. Improvements to the baseline localization performance of BLE-based approaches (i.e., more than one meter) to bring the localization performance under less than 0.5 meters was observed. The method was further tested in an indoor space where six individuals were asked to move around. Additionally, the effect of the length of the trajectory stored in IPS is also investigated to study the impact on the performance. The proposed system shows some improvements in overcoming the limitations of computer vision (i.e., id switching and the requirement to store digital profiles), but the overall localization of tracking performance is not as good as the CV-IPS. Furthermore, since the multimodal indoor positioning systems and methods can identify the users anonymously (using their mobile phones), just using CV-IPS locations does not provide the users' identifiers.

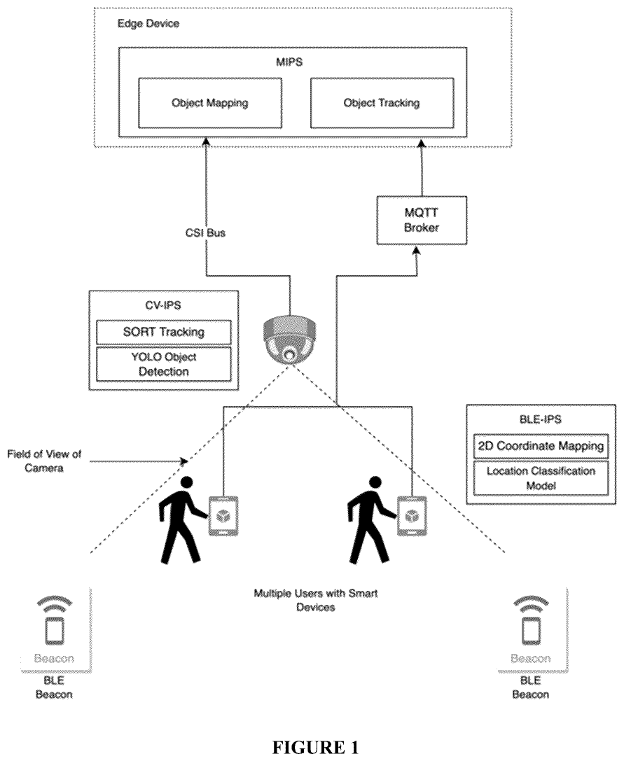

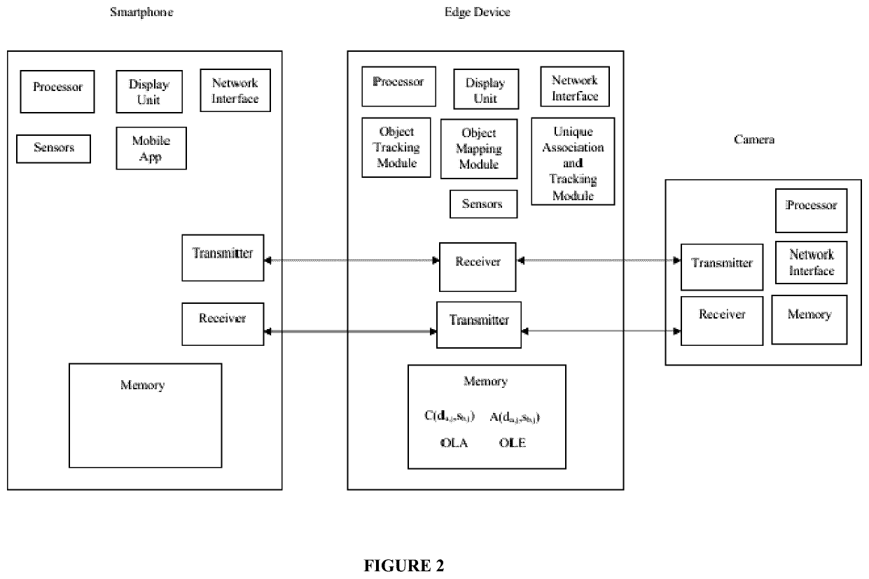

FIGS. 1 and 2 show the system architecture of the proposed MIPS system. The system contains various sensors, including Bluetooth beacons, smartphone devices carried by human subjects, and an overhead camera. The individuals captured by the overhead camera (i.e., in the field of view of the camera) are considered for localization. The app on the smartphone collects the RSSI signals from the BLE beacons in the indoor space. The app also estimates the location of the smartphone. This location information is transmitted to the edge device along with the pseudo device id. On the other hand, the overhead camera captures the video and identifies the humans in the field of view. A temporary tracklet ID is assigned to individual, with the existing ids begin tracked. The edge device has the MIPS system that fuses location estimates from BLE and computer vision applications. The proposed MIPS is present on the edge device where the mapping and tracking are performed.

Unlike BLE-IPS, CV-IPS cannot identify users (without biometric features) but can learn to recognize them as generic “objects” and assign tracking ID to track their movement across image frames. The MIPS then processes the outputs from the BLE-IPS and CV-IPS subsystems. As shown in FIG. 1, using the two sets of 2D position coordinates, the MIPS mapping module first matches the user's pseudo-id to the tracklet-ID assigned to them by the CV-IPS module. It then ties the high precision 2D localization from the CV-IPS module to achieve multi-user unique association and tracking. The system can track the mobile devices over time and self-correct when new tracking IDs are generated due to ID switching or Occlusions.

The indoor space I is divided into a p×q grid configuration, where each grid cell is a 1 m×1 m. The space has k Bluetooth beacons B={b₁, b₂, . . . , bₖ}, and overhead camera C. The goal of the system is to efficiently detect and track individual devices D={d₁, d₂, . . . , dₙ} in near-real-time. The BLE feature from mobile devices generates an anonymous identifier from the mobile app, which is the only object tracked over time for localization and tracking.

BLE-IPS detects the location of the device d, at time tⱼ using a set of RSSI values, R_{i,j}={b_{1,i,j}, b_{2,i,j}, . . . , b_{k,i,j}}, where k is the number of BLE beacons. The RSSI signal strength is impacted by several factors like the number of beacons, the positioning of beacons, the number of objects, and the distribution of objects in the indoor space [37]. To reduce the impact of noise on the quality of the RSSI signals while detecting the device's location, a sliding window [38], [39] was used. The instance of data for a device dᵢ at time tⱼ is represented by d_{i,j}=<R_{i,j,k}, R_{i,j-1,k}, . . . , R_{i,j-p,k}>where p is the length of the window considered for BLE-IPS and 1≤k≤bn, and bn is the number of beacons.

A classification model is trained to detect the grid location of device at each time period, where the target variable is each of the p×q grid cells where the object s, carrying device dᵢ is present at time tⱼ. The center of the grid box location lb_{i,j}=(x_{lbi,j}, y_{lbi,j}) is considered the location of the Bluetooth device dᵢ at time tⱼ. Random forest-based classification is used to identify a device's location. The features include the mean RSSI strength, the variance, and the skewness of the RSSI signal for each beacon over the p time periods. A set of k×3 features were extracted from the k beacons for a device d at each time period.

The CV-IPS assigns a tracking ID to each object that can track these objects over time. At each timestep, m tracking ids were identified tracking ids, TR={tr₁, tr₂, . . . , trₘ}, where m may or may not be equal to the number of devices, n. Each tracking ID trᵢ corresponds to an object; this tracklet ID persists as long as the object associated with that tracklet is continuously identified in the indoor space. If the object leaves the space or is not continuously identified, a new tracklet ID is generated for that object.

CV-IPS implementation has two modules: object detection and object tracking. YOLOv3-tiny was used has the base Object Detection model for CV-IPS object detection [40]. YOLOv3-tiny has 36 layers in total containing 8.66 million trainable parameters. YOLOv3-tiny predicts bounding box location and class labels twice in two densely connected layers (sometimes referred to as a YOLO layer) to detect large and medium-sized objects, respectively, and concatenates the outputs at the end. For object tracking, a Simple Online and Real-time Tracking (SORT) [41] model is chosen as the Multi-Object Tracking (MOT) model. Initially, SORT assigns a random integer number starting from 1 for each detected object. Then, for each batch of detected objects, SORT forms a similarity matrix by calculating the Intersection-over-Union measure (also known as Jaccard's Index) by comparing the degree of overlap between the current bounding boxes to the last known bounding boxes assigned to a track using:

$$IoU = \frac{\vert A ⋂ B \vert}{\vert A ⋃ B \vert} . \qquad ( 1 )$$

The center of the bounding box lc_{i,j}=(x_{lci,j}, y_{lci,j}) is considered the location of an object associated with tracketlet ID trᵢ at time tⱼ.

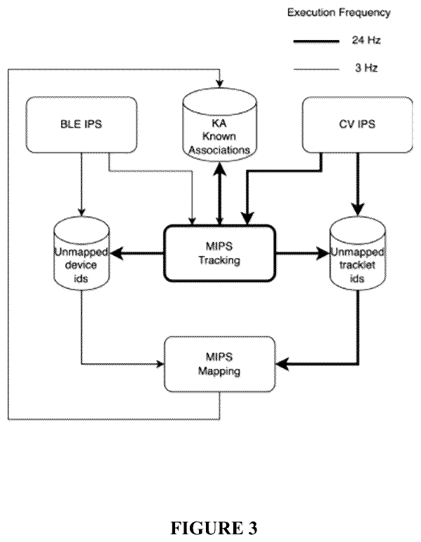

The overall MIPS-based location detection system workflow is shown in FIG. 3. The BLE-IPS and CV-IPS systems generate locations along with object identifiers in real-time. The BLE-IPS generates mobile device ids, and CV-IPS generates tracklet IDs along with locations. When users first enter the tracking area, the device id and the tracklet IDs are unmapped (status=0), and the MIPS mapping system maps the ids based on trajectories. BLE-IPS is part of a mobile app carried by the users that collect RSSI values from BLE beacons at regular intervals and generates location estimates. These location estimates are then transmitted to the edge device for MIPS mapping. Similarly, the CV-IPS is part of the edge device connected to the overhead camera. The CV-IPS generates tracklet IDs along with the locations. The locations generated by the CV-IPS are more reliable; however, the object identifier is not known.

The MIPS system takes the object identifiers along with the locations generated by both the CV-IPS and BLE-IPS. The BLE-IPS knows the actual device with unreliable location and the CV-IPS generates an accurate location but an unknown device (or person). Also, the trajectories from BLE-IPS and CV-IPS are generated at different frequencies. The BLE-IPS detects location at a frequency of 3 Hz (333 ms), whereas the CV-IPS has a frequency of 24 Hz (41.67 ms); The MIPS system maps and tracks the trajectories from BLE-IPS and CV-IPS trajectories at 3 Hz using the latest information available from both the locations. Once an association has been verified (i.e., tracked), the known location of the object is updated at a higher frequency of 24 Hz. The Siamese network model that is part of the MIPS system takes two independent trajectories to map the device identifier to the correct location. The mapped device locations (known associations) are then transmitted to the MIPS tracking system. The tracking system detects wrong associations based on the distance between two trajectories of BLE-IPS and CV-IPS of a mapped association increases over time. In the event of an id switch, the association is considered invalid, and the device and tracklet identifiers are put into the unmapped device list, which is then sent back to the MIPS mapping system. Mapping is performed to associate a device identifier da from BLE-IPS to a tracking identifier tr_{b} from the CV-IPS.

The trajectory T_{da}={L_{(1, da)}, L_{(2, da)}, L_{(3, da)}, . . . , L_{(n, da)}} and T_{trb}={L_{(1, trb)}, L_{(2, trb)}, L_{(3, trb)}, . . . , L_{(n, trb)}} are trajectories of length n for both the device da and person tr_{b}. L_{(i,id)} represents the location at a time i from the input id, where it can be BLE-IPS or CV-IPS. The multimodal indoor positioning systems and methods can map an unassociated device trajectory from BLE-IPS with an unassociated human trajectory from CV-IPS. If there is only a single pair of unassociated devices and tracking IDs at a given timestep, an association is mapped without additional processing. However, more than one pair of unassociated device and tracking IDs may be present at a given time step. The multimodal indoor positioning systems and methods can include Siamese networks to map the device and the tracklet ID accurately.

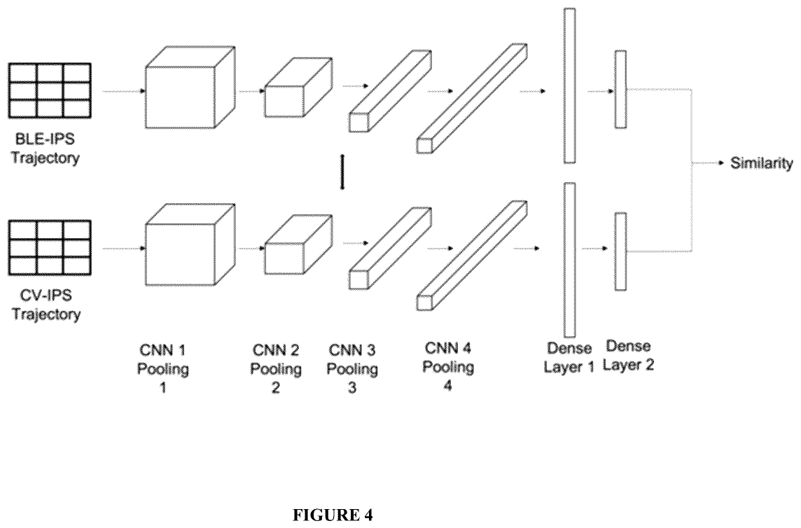

Siamese Networks: A Siamese network has two parallel sub-networks, each of which encodes a value in a tuple, the input to each sub-network. A tuple consists of a trajectory, which belongs to the outputs from BLE-IPS and the CV-IPS corresponds to each sub-network. The two sub-networks share the same weights and architecture in Siamese architecture. Each sub-network, designed as a simple convolution neural network, learns from the trajectory and maps them to a representative vector. The final representation of the trajectory is encoded by the last hidden state of the subnetwork. Given two trajectories, one from each of the BLE-IPS and CV-IPS, the semantic similarity in the trajectory segments is inferred by determining the similarity in the vector space. The training samples used to train the Siamese network are in the form of tuples (T_{d}, Tₜᵣ, y). The label y=0 indicates that T_{d}_{ₐ} and Tₜᵣ_{_{b}} belong to the different individuals, and y=1 indicates that T_{d}_{ₐ} and Tₜᵣ_{_{b}} are of the same type. Two inputs trajectories T_{d}_{ₐ} and Tₜᵣ_{_{b}} are received and then converted into an n×m matrix, where n is the length of the trajectory and m is the grid size of the locations. This input matrix from T_{d}_{ₐ} and Tₜᵣ_{_{b}} is vectorized into v(T_{d}_{ₐ}) and v(Tₜᵣ_{_{b}}), respectively, using a CNN. During the training of the Siamese network, the backpropagation error comes from the similarity between v(T_{d}_) and v(Tₜᵣ_) and the degree of deviation between the predicted similarity and the real label. An illustration of the Siamese network is provided in FIG. 4. This will force the sub-network to capture the semantic differences in the trajectory segments during the training process. The distance D between the two output vectors is calculated using a distance metric, and the loss is calculated using the D value to train the Siamese network. In this mapping technique, the goal is to identify those locations that the BLE-IPS determines with high confidence and map those to the CV-IPS simultaneously.

It should be noted that the number of unassociated tracking IDs might not always match the number of available device IDs. This is due to the object detection performance of the CV-IPS, where particular objects are misclassified as humans, or a group of objects is labeled using a single tracking ID.

The MIPS tracking system continuously tracks the distance between the BLE-IPS and CV-IPS generated trajectories of known associations. The distance between the BLE location lbₐ, and CV location lc_{b} of an association<dₐ, s_{b}>increases over time. The distance between device dₐ and tracking ID tr_{b} at time tⱼ is represented by D(d_{a,j}, tr_{b,j}) and is calculated using the formula:

$$D ( {d}_{a , j} , {s}_{b , j} ) = \frac{{\sum }_{t = 0}^{p} C ( {d}_{a , j - t} , {s}_{b , j - t} )}{p} , \qquad ( 2 )$$

where p is the number of time periods where the association is tracked. An association is considered valid if D(d_{a,j}, s_{b,j})≤a. If the distance is greater than a, the association is considered invalid, and the device and the tracking IDs are added to the unmapped device and tracking pools. For the set of experiments, the value of a is 150 cm. While there is a chance that an invalidated association can be mapped in the next timestep, practically, this scenario has a low probability of occurrence. The distance increases when the mapping is incorrect as the distance between dₐ and s_{b} increases. Given a list of unmapped devices and tracking IDs, a matrix of distances between the predicted BLE-IPS locations of device IDs and the predicted CV-IPS locations of the tracklet IDs is generated. A Siamese network is used to identify the list of associations between device IDs and tracklet IDs. It is probable that some devices and tracklet IDs are not mapped; these are then passed to the next IPS mapping along with the known associations.

### EXAMPLES

To provide a better understanding of the foregoing discussion, the following non-limiting examples are offered. Although the examples can be directed to specific embodiments, they are not to be viewed as limiting the invention in any specific respect.

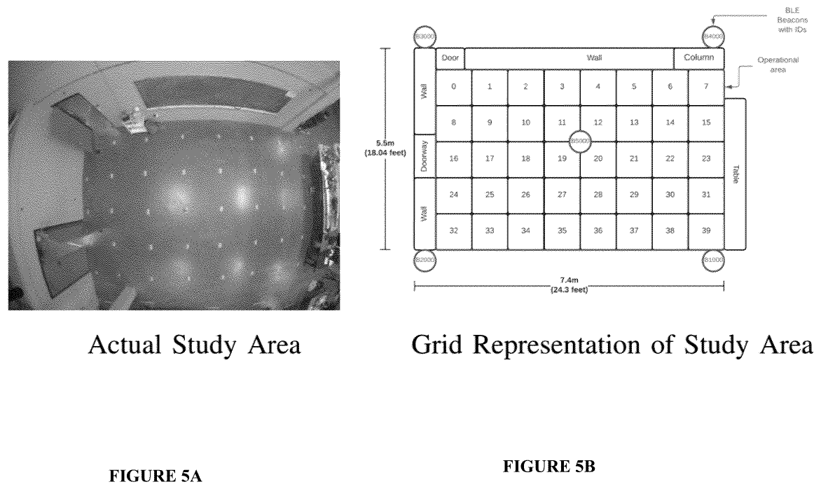

The performance of multi-modal indoor localization and tracking was evaluated in an indoor environment. The testbed was equipped with BLE beacons, an overhead camera, and computational infrastructure for indoor localization and tracking. Individuals used mobile phones for localization. The study area is shown in FIG. 5a from the overhead camera, and the grid area representation and placement of beacons are shown in FIG. 5b. The room dimensions are 7.4 m×5.5 m divided into a 40-cell grid, where each location is a grid that is approximately 1 m×1 m. Five Estimote Bluetooth Proximity BLE Beacons were placed at five locations in the study area, four on the four corners of the study area, and one at the center of the study area. Six Android smartphones were used, each of which was assigned to one user throughout the experiment. A custom mobile phone app was developed to collect RSSI signal data from various BLE beacons and calculate the approximate location from the RSSI signals. The mobile app anonymously transmits location information to the edge device.

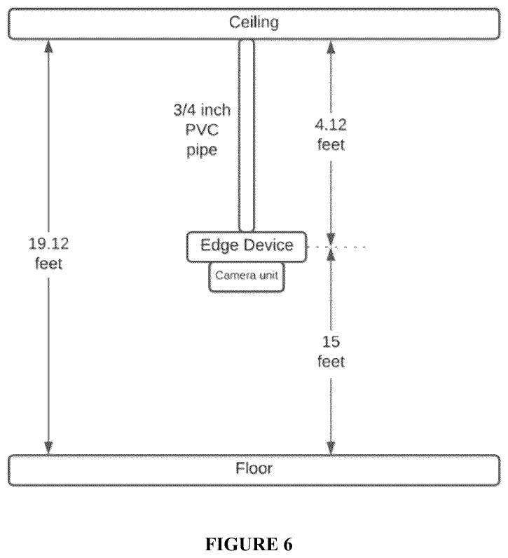

The Edge device chosen for the experiment is the Nvidia Jetson Xavier NX AI computing kit from Nvidia, which comes equipped with an integrated 384-core NVIDIA Volta GPU with 48 Tensor Cores clocked at 1.1 GHz, 6-core NVIDIA Carmel ARMv8.2 64-bit CPU running at 1.4 GHz and 8 GB 128-bit LPDDR4x. The edge device is also equipped with an overhead camera. An overhead camera unit and the Edge device were placed at the center of the observation area 15 feet high from the ground level, as shown in FIG. 6.

Six subjects were given a mobile device and an overhead camera was used to track their movements in the indoor space. The mobile device was tracked using a mobile app that obtained data from BLE beacons. Various tracking experiments were conducted with different starting positions, varying numbers of people tracked at a single instance, and movement dynamics. All the subjects are in the field of view of the overhead camera. The primary objective was to evaluate if the localization performance of BLE-IPS can be improved with the MIPS model. The machine learning models used in the BLE-IPS model are trained and tested for each scenario separately rather than having a generalized or pre-trained model. The CV-IPS model uses a pre-trained overhead object detection model [42]. The default window size for MIPS-based real-time tracking is set to 5 seconds, but the effect of varying window sizes was also evaluated.

The initial association between the two tracking identifiers becomes straightforward when the objects are separated in space and time. The following are the five scenarios created to evaluate the performance of MIPS when individuals enter the space with minimum and maximum inter-object distance:
Scenario 1: 4 people enter with a high inter-object distance (individuals enter from 4 corners) and no one leaves the tracking space
Scenario 2: 6 people enter with medium inter-object distance (individuals enter from 4 corners and 2 sides) and nobody leaves the tracking space
Scenario 3: 6 people enter with medium inter-object distance (4 individuals enter from one side and 2 from the opposite side), 3 individuals leave the tracking space
Scenario 4: 5 people with low inter-object distance and 1 individual enter from the opposite side, 4 individuals leave the study area
Scenario 5: 5 people with low inter-object distance and 1 individual enter from the opposite side, 2 individuals leave the scene.

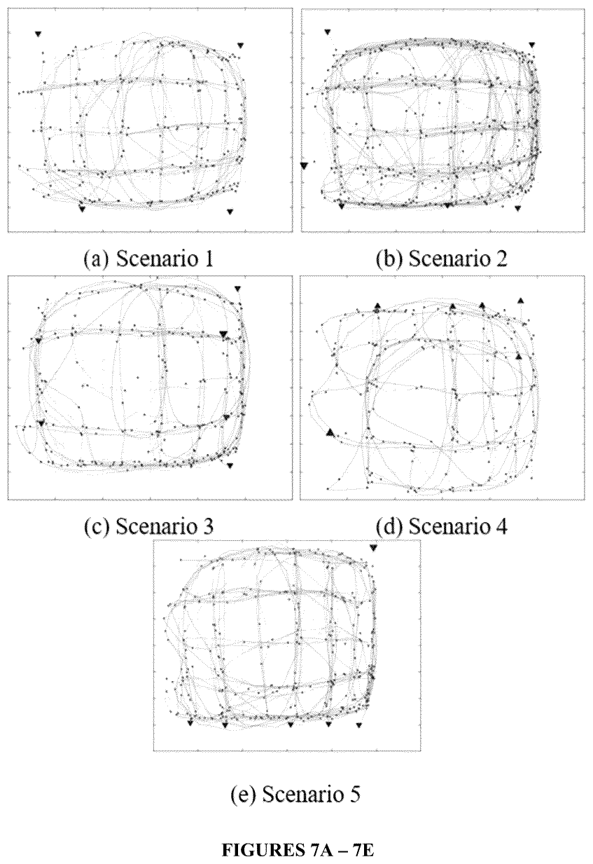

FIG. 7 shows the entry points (represented by a triangle) and users' trajectories created from the computer vision system.

The tracking and localization scenarios were evaluated using two performance metrics: Object Localization Accuracy (OLA) and Object Localization Error (OLE).

Object Localization Accuracy

1) Object Localization Accuracy: OLA is the fraction of cells for which the predicted grid cell matches the ground truth grid cell of the object:

$$OLA = \frac{{\sum }_{j = 0}^{n} {a}_{j}}{{\sum }_{j = 0}^{n} {I}_{j}} , \qquad ( 3 )$$

where aⱼ is the total number of accurately predicted grid cells over the trajectory for object j and Iⱼ is the total number of grid cells for trajectories for object j during the scenario, and n is the total number objects.

2) Object Localization Error: OLE is the average distance between the actual and predicted location (i.e., the coordinates) for each object throughout the object's trajectory:

$$OLE = \frac{{\sum }_{i = 0}^{t} {\sum }_{j = 0}^{n} {A}_{i , j} - {P}_{i , j}}{t \times n} , \qquad ( 4 )$$

where t represents the numbers of time-steps in the trajectory of the object, and n is the total number of objects. The actual and the predicted coordinates of the object j at the time i are represented by A_{i,j} and P_{i,j}.

The performance of MIPS is compared to BLE-IPS with respect to OLA and OLE using the five scenarios. First, the performance of CV-IPS is discussed. However, CV-IPS cannot track or uniquely identify individual mobile devices but can only track objects in the camera field of view using a pseudo identifier. Hence, the performance of CV-IPS when the device identifiers are known is addressed. Then, the performance of MIPS is analyzed by comparing the OLA and OLE to BLE-IPS as a baseline. Finally, the computational time required for location prediction for MIPS is also discussed.

### Performance of CV-IPS

An annotated image dataset with 9967 images of individuals from an overhead camera in the indoor space was used for training the model and tested against each scenario used in the experiments. Table 2 shows that the YOLOv3-tiny model achieves an accuracy of 97.5% when detecting an individual within 23.2 cm of the actual position. The CNN model works efficiently with a 160-degree FOV for localizing multiple users since the SORT algorithm depends on how well YOLOv3-tiny differentiates people from other objects in the image sequence.

TABLE 2
OLA and OLE for CV-IPS

| Scenario | OLA | OLE (cm) |
|---|---|---|
| s1 | 97.90% | 26.5 |
| s2 | 98.00% | 30.1 |
| s3 | 98.10% | 27.1 |
| s4 | 97.40% | 26.6 |
| s5 | 97.90% | 28.6 |

One of the problems with assigning pseudo-identity in computer vision is that the tracklet ID associated with an object changes over time due to id-switching. While the CV-IPS is highly effective at localizing objects, identifying and tracking the user's trajectory from an overhead camera is non-trivial [43], especially when people cross each other. Table 3 presents the number of ID switches, and the number of unique tracklet IDs generated for each scenario. The occlusion percentage increases as the number of individuals increases (as observed in scenarios 2 and 3). ID switches also increase as the object trajectories cross, resulting in switched tracklet IDs. In addition, the CV-IPS assigns a new tracklet ID to any re-identified object. This poses a challenge when an object is not detected or returns to the study area because the CV-IPS model cannot re-identify the same individual at a later time. To overcome the issue of uniquely identifying a user, the BLE-IPS identifier was used. When MIPS cannot accurately map the CV-IPS and BLE-IPS, the overall tracking and localization performance is affected.

TABLE 3
Number of Users, ID Switches, and Tracklet
IDs for Different Scenarios For CV-IPS

| | Number | Number of ID | Number of Unique |
|---|---|---|---|
| Scenario | of Users | Switches | Tracket ids |
| s1 | 4 | 11 | 14 |
| s2 | 6 | 26 | 19 |
| s3 | 6 | 14 | 17 |
| s4 | 6 | 12 | 13 |
| s5 | 6 | 19 | 18 |

### MIPS Location Detection and Tracking Performance

The results show that the MIPS location detection system improves location detection accuracy substantially over the traditional Bluetooth-based location positioning system. The BLE-based indoor tracking systems have a localization error that ranges from 1 m to 2 m, similar to prior research [9] for all the five scenarios.

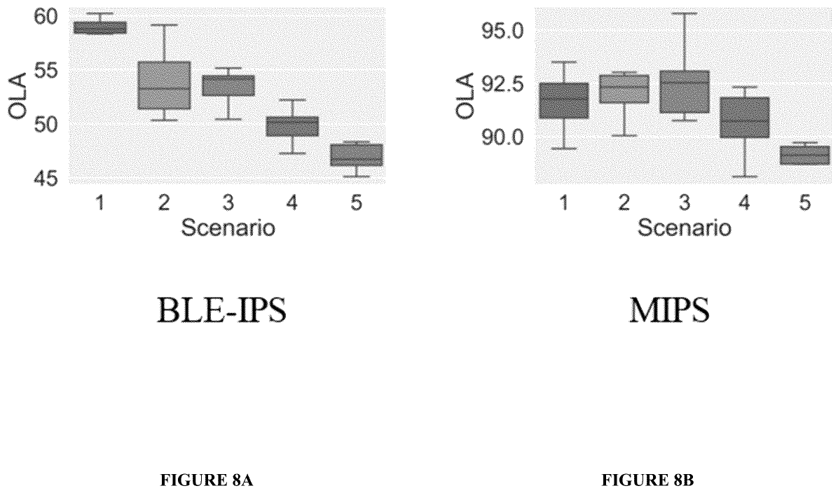

FIG. 8 shows that the average OLA of MIPS across all the scenarios increases to 91.11% compared to BLE-IPS, where the average accuracy is 47.53%. The OLA accuracy for all the scenarios is greater than 88% for all individuals across the scenarios. Scenarios 1 and 2 have better performance than scenarios 3-4 for BLE-IPS and MIPS. In these two scenarios, the number of objects stays the same throughout the experiment. In scenarios 3, 4, and 5, the inter-object distance between the human subjects is lower, leading to increased errors due to id switching. In addition, the individuals leave the study area at regular intervals, disconnect their Bluetooth, and enter the study area later. The aforementioned issues reduce the performance of BLE-IPS, which negatively impacts MIPS performance.

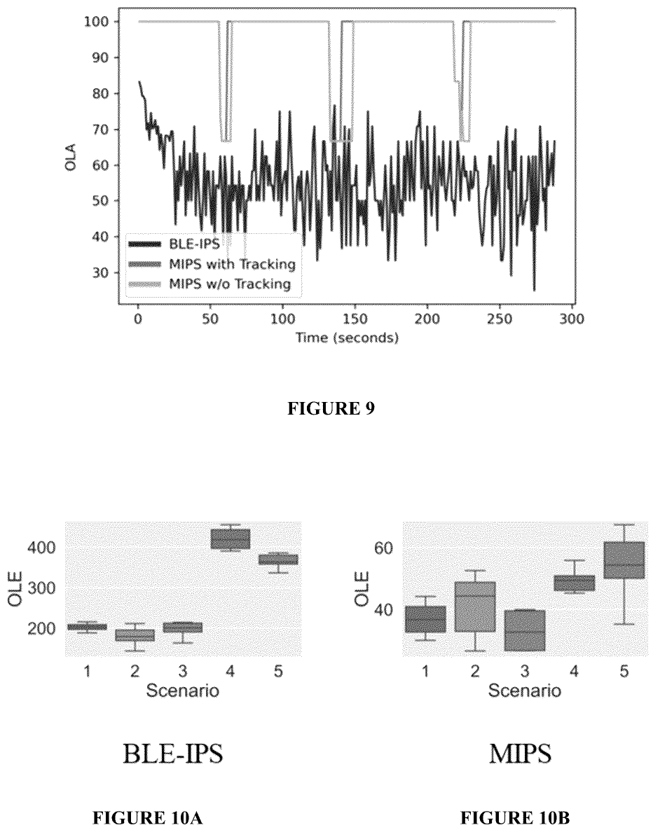

The OLA accuracy over time for scenario 5 is provided in FIG. 9 using BLE-IPS, MIPS without tracking, and MIPS with tracking. The accuracy of the BLE-IPS is 85% when the experiment starts, then decrease to 50% as individuals start moving and remain at 50% for the rest of the scenario. The high accuracy at the beginning of the experiment is due to stable Bluetooth signals to ensure accurate localization of individuals in the study area. This high accuracy and CV-IPS location detection results in a higher association rate between the device ID and the tracklet ID. Due to the swapping of tracklet IDs between objects, the OLA is reduced to 66.67% three times during the scenario. However, the tracking component in MIPS breaks the incorrect associations. On the other hand, MIPS without tracking can only recover when a new tracklet ID has been generated for the original MIPS or if there is an ID switch.

FIG. 10 shows the OLE performance. The average OLE performance improves from about 2.8 m for the BLE-IPS system to 0.40 m for the MIPS approach. The MIPS shows a 40.8% improvement in OLE compared to BLE-IPS. However, the localization error for MIPS is still higher than the OLE of CV-IPS, which is 0.29 m on average across all objects in all scenarios. There were differences observed between employing BLE-IPS and the MIPS approaches for various scenarios. For example, in scenarios where the participants move in and out of the tracking area, the precision of BLE-based location detection is significantly lower than in scenarios where all the individuals are present in the study area. The BLE OLE is 3.6 m for scenario 2, whereas the OLE for MIPS is 0.44. The location errors identified by either BLE-IPS or CV-IPS are propagated into the MIPS algorithm when an association between the device ID and the tracking ID. Thus, tracking the association results in improved performance with respect to both OLA and OLE.

In evaluating various scenarios, the OLA is higher where the number of participants is constant during the entire duration of the experiment. This observation is accurate for BLE-IPS and, to a lesser degree, MIPS. On the other hand, the BLE-IPS OLA is lower when the participants move in and out of the study area, which requires new Bluetooth connections to the devices and participants moving around. There were no significant changes in the OLA and OLE when participants increased from 4 to 6 in scenarios 1 to 2.

### Impact of Trajectory Length on the Performance of MIPS

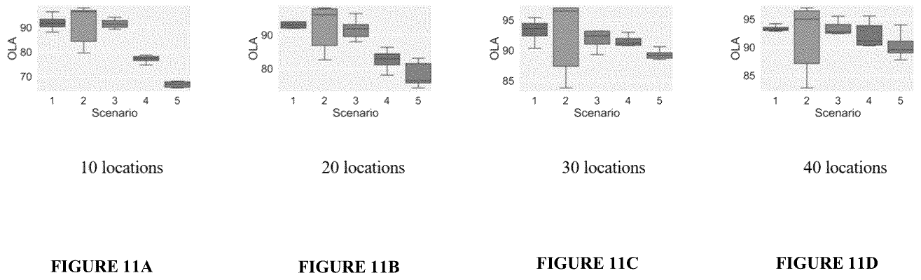

Incorporating additional data points into the trajectories in the mapping and the re-association process improves object localization performance. But increasing the stored trajectory length also increases the object localization time. It is therefore desirable to have a model that uses a small sample of the most recent data for localization. The impact of using historical trajectories from 10 locations (3.33 seconds) to 40 locations (13.33 seconds) were compared. The impact of trajectory length stored on the OLA is presented in FIG. 11.

It was observed that the average OLA increases from 83.51% for a trajectory of length 10 to 87.2% for trajectory of length 20, ⁹1.7% for 30, and 92.03% for 10 locations, respectively. Table 4 presents the OLA of each scenario for different trajectory lengths. As the length of stored location trajectory mappings increases, the accuracy of the association between BLE ID and the CV tracking ID also increases. In addition to increased accuracy of mappings, the MIPS enables the correction of incorrect associations mapped during the previous time periods either due to ID switch of the CV-IPS system or inaccurate location detection by the BLE IPS system. There are improvements in the performance of MIPS across all scenarios compared to Bluetooth.

TABLE 4
OLA for various tracking window lengths

Trajectory Length

| Scenario | 10 | 20 | 30 | 40 |
|---|---|---|---|---|
| Scenario 1 | 91.99 | 92.96 | 93.24 | 93.37 |
| Scenario 2 | 91.36 | 92.56 | 92.56 | 93.88 |
| Scenario 3 | 91.56 | 92.78 | 92.65 | 92.99 |
| Scenario 4 | 77.16 | 90.38 | 91.23 | 92.17 |
| Scenario 5 | 68.33 | 86.94 | 89.31 | 90.22 |

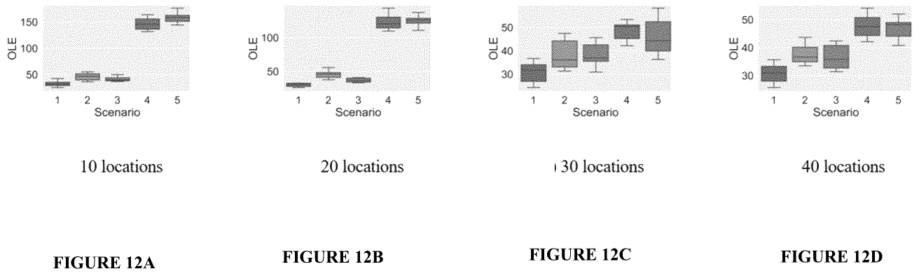

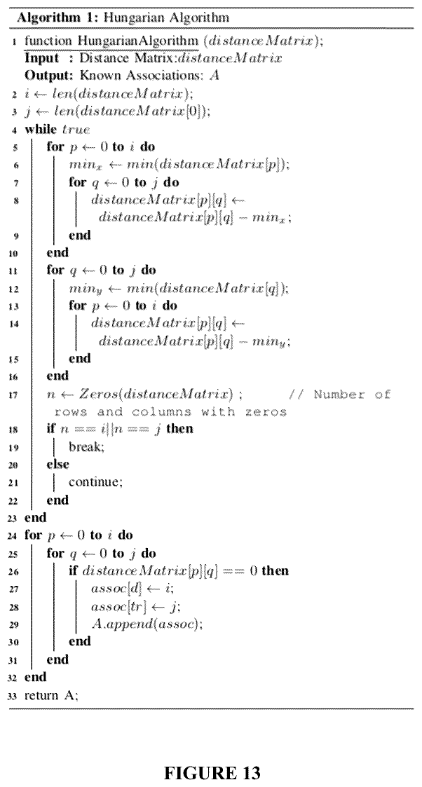

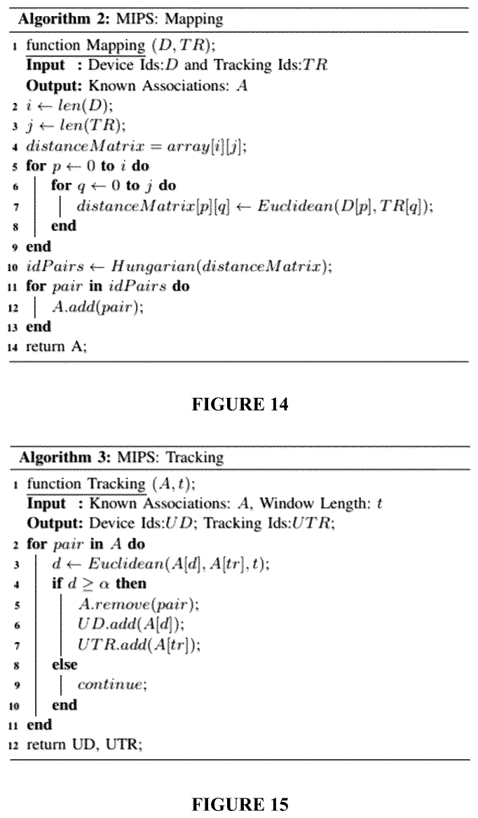

The improvement is more pronounced in scenarios 2, 3, 4, and 5, where there are high occurrences of occlusion and ID switches. The location of the user is inaccurate if an id switch leads to an incorrect mapping. The ID switches in scenario 2 lead to a higher number of incorrect associations; therefore, validating the trajectories overtime improves the mapping accuracy. Thus the OLA increases from 91.35% to 93.88% on average. Similarly, higher id switches lead to a higher error rate in scenarios 3, 4, and 5, where tracking the associations using trajectories irons out the high number of tracklet IDs from CV-IPS. Thus improving the OLA accuracy. As the length of the window increases, the ability of the MIPS to identify wrongly associated device ID and tracklet ID pairs increases. This leads to substantial improvements for MIPS as the trajectory length increases from 10 to 40. This increase in OLA performance of MIPS is primarily through tracking rather than the improvement with the same performance for both BLE and CV-IPS. FIG. 12 provides the OLE associated with MIPS for various time periods under consideration for the association. The results show that the OLE improves substantially between trajectory lengths of 10 and 20 locations (i.e., 3.3 seconds to 6.7 seconds) from 0.89 m to 0.45 m, and the OLE is 0.39 m for a trajectory length of 40. It should be noted that while OLA is close to 100, the OLE is not substantially closer to 0; that is because of the error in estimating the bounding box compared to the center of the grid point. Thus, 0.23 m should be a floor on the accuracy achieved by the proposed system. Table 5 presents the OLE of each scenario using different tracking lengths.

TABLE 5
OLE for various tracking window lengths

Trajectory Length

| Scenario | 10 | 20 | 30 | 40 |
|---|---|---|---|---|
| Scenario 1 | 32.71 | 29.37 | 31.78 | 28.72 |
| Scenario 2 | 45.89 | 39.82 | 38.35 | 37.72 |
| Scenario 3 | 41.52 | 36.66 | 38.32 | 36.61 |
| Scenario 4 | 146.69 | 62.12 | 48.56 | 47.75 |
| Scenario 5 | 158.41 | 59.92 | 46.14 | 46.86 |

### Execution Time

Table 6 shows the end-to-end time taken to identify the locations from BLE-IPS and CV-IPS, perform mapping and tracking to identify the associations and extract locations.

TABLE 6
Execution time in ms for various IPS approaches

| | | | | MIPS | MIPS | MIPS |
|---|---|---|---|---|---|---|
| Scenario | BLE-IPS | CV-IPS | MIPS(10) | (20) | (30) | (40) |
| s1 | 48 | 28.9 | 136.9 | 149.4 | 161 | 168.12 |
| s2 | 58 | 31.8 | 186.4 | 195.2 | 214.9 | 234.5 |
| s3 | 53.9 | 28.7 | 163.1 | 204.5 | 227.1 | 241.4 |
| s4 | 52.8 | 29 | 177.3 | 194.5 | 213.4 | 231.2 |
| s5 | 54.4 | 29.7 | 172.9 | 201.9 | 209.9 | 228.7 |

The vast majority of the required time is for the MIPS system to map the trajectories. The BLE system takes about 56.4 milliseconds on average, and the CV-IPS takes 29.3 milliseconds to assign a tracklet ID. The CV-IPS system considers both the BLE ID and the tracklet ID to generate an association and assign the CV-IPS location to a particular BLE pseudo-id. The time taken to perform an association over time is a minor increase over the spatial association. The amount of time increases as the number of historical locations increases. RSSI-based localization has become increasingly popular despite poor accuracy because of its low cost and complexity.

The multimodal indoor positioning systems and methods can include a multi-modal localization approach to improve the performance of BLE by integrating an overhead camera. The experiments conducted were under controlled conditions in a 1×1 m grid where the RSSI signals are reachable across the study space, and the subjects are in the field of view. This study was important to test and evaluate the system at low resolution in the presence of multiple subjects, which is an improvement compared to existing studies that tracked fewer subjects in a wide area [44], [45]. The presence of multiple beacons and the presence of humans and mobile devices capturing RSSI measurements introduce fluctuations in RSSI signal due to interference from multipath propagation or shadowing of obstacles. The current experimental setup does not include any line of sight issues and occlusions for both BLE and CV-IPS systems. The impact of occlusions and signal fading should be evaluated for both signals by expanding the study to further investigate how these techniques would perform when there are obstructions in the field of view and subjects. The MIPS methods can be improved with hierarchical localization and multi-modal deep learning approaches. The time required for the BLE system to register and track users can be further improved. In the experiments, the system takes about 3 to 5 seconds to register with the system. The users connect to the BLE system before entering the experimental study area, but the data collected before entering the study area is discarded for a fair assessment of all techniques within a controlled environment. The performance of tracking was also shown to perform well for varying window lengths, but the study did not include the time for mobile devices to register with the system. This limitation should not affect the system's performance within the study area, but the study did not consider situations where people are present only for a short duration (i.e., less than 5 seconds) or if multiple people enter the space at the same time (such as a single door). Third, this analysis was performed for a 1 m×1 m grid; the size of the grid also has an impact on the performance of the location detection, a finer grid size will reduce the object location accuracy, and a coarser granularity will increase OLE. A balance between these two metrics needs to be achieved for different grid sizes.

A Siamese network-based multi-modal indoor positioning system for mapping and tracking users in indoor spaces has been demonstrated. The system first generates location trajectories of users' mobile devices (from BLE-IPS) and the overhead camera-based CV-IPS. Then, these location trajectories are mapped using the Siamese network. Numerous experiments were performed to evaluate the performance of the MIPS system. The MIPS system can localize users with a error of 0.40 m compared to BLE, which has an average error of 2.8 m. The localization of the user within a 1 m×1 m grid is above 90% for all scenarios using the MIPS system; however, for the baseline BLE-IPS system, the accuracy is 47.53%. These baseline performances are similar to earlier analysis of the BLE systems [9]. The impact of the duration of the historical trajectory used in the model on the localization error and accuracy was also investigated. Increasing trajectory history improves the accuracy of mapping CV-IPS and BLE-IPS. But increasing the trajectory history would increase the time for the IPS system to match trajectories. Analysis shows that the average OLE decreases from 0.85 m to 0.40 m, and the OLA increases from 84.08% to 91.11% when trajectory length increases from 10 to 40. The MIPS system can map and track an individual on an average of 167.32 ms for a trajectory length of 10, compared to 56.4 ms for BLE-IPS and 29.3 ms for CV-IPS. The execution time increases to 220.78 ms for a trajectory length of 40. These times would enable the MIPS to map and track individuals in near real-time.

The multimodal indoor positioning systems and methods can include a multimodal sensing approach that combines the location trajectories extracted from two signals, i.e., BLE and computer vision. The multimodal indoor positioning systems and methods can fuse the location estimations from BLE fingerprints and computer vision to improve localization performance. The mobile phone periodically generates location estimates using fingerprints generated from RSSI, and an overhead camera generates location estimates using computer vision by tracking people. Both these location estimates are fused to generate location estimates for each device identifier. Since the approach uses device identifiers generated from BLE to link to the user, these device identifiers can be anonymized. The multimodal indoor positioning system was rigorously tested in an indoor environment where people carrying the mobile devices were asked to move in the tracking space. The approach overcomes the limitations of computer vision (e.g., occlusion and the requirement to store digital profiles) and the localization performance of BLE-based approaches (e.g., more than one meter) to bring the localization performance to one meter.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections. Some implementations include electronic components, for example microprocessors, storage and memory that store computer program instructions in a machine-readable or computer-readable medium (alternatively referred to as computer-readable storage media, machine-readable media, or machine-readable storage media, any or all of which can be non-transitory). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Various terms have been defined above. To the extent a term used in a claim is not defined above, it should be given the broadest definition persons in the pertinent art have given that term as reflected in at least one printed publication or issued patent.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits may be the values from the examples. Certain lower limits, upper limits and ranges appear in at least one claims below. All numerical values are “about” or “approximately” the indicated value, and consider experimental error and variations that would be expected by a person having ordinary skill in the art.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. As used herein, use of the term “including” as well as other forms, such as “includes,” and “included,” is not limiting.

All patents, patent applications, provisional applications, and publications referred to or cited herein are incorporated by reference in their entirety, including all figures and tables, to the extent they are not inconsistent with the explicit teachings of this specification.

### REFERENCES

1. L. Sevrin, N. Noury, N. Abouchi, F. Jumel, B. Massot, and J. Saraydaryan, “Characterization of a multi-user indoor positioning system based on low cost depth vision (kinect) for monitoring human activity in a smart home,” in 2015 37th Annual International Conference of the IEEE Engineering in Medicine and Biology Society (EMBC). IEEE, 2015, pp. 5003-5007.
2. V. Stavrou, C. Bardaki, D. Papakyriakopoulos, and K. Pramatari, “An ensemble filter for indoor positioning in a retail store using bluetooth low energy beacons,” Sensors, vol. 19, no. 20, p. 4550, 2019.
3. L. C. Huey, P. Sebastian, and M. Drieberg, “Augmented reality based indoor positioning navigation tool,” in 2011 IEEE Conference on Open Systems. IEEE, 2011, pp. 256-260.
4. P. G. Madoery, R. Detke, L. Blanco, S. Comerci, J. Fraire, A. G. Montoro, J. C. Bellassai, G. Britos, S. Ojeda, and J. M. Finochietto, “Feature selection for proximity estimation in covid-19 contact tracing apps based on bluetooth low energy (ble),” Pervasive and Mobile Computing, vol. 77, p. 101474, 2021.
5. A. R. J. Ruiz and F. S. Granja, “Comparing ubisense, bespoon, and decawave uwb location systems: Indoor performance analysis,” IEEE Transactions on instrumentation and Measurement, vol. 66, no. 8, pp. 2106-2117, 2017.
6. F. Zafari, A. Gkelias, and K. K. Leung, “A survey of indoor localization systems and technologies,” IEEE Communications Surveys & Tutorials, vol. 21, no. 3, pp. 2568-2599, 2019.
7. P. van den Berg, E. M. Schechter-Perkins, R. S. Jack, I. Epshtein, R. Nelson, E. Oster, and W. Branch-Elliman, “Effectiveness of three versus six feet of physical distancing for controlling spread of covid-19 among primary and secondary students and staff: A retrospective, state-wide cohort study,” Clinical infectious diseases: an official publication of the Infectious Diseases Society of America, 2021.
8. X. Guo, N. R. Elikplim, N. Ansari, L. Li, and L. Wang, “Robust wifi localization by fusing derivative fingerprints of rss and multiple classifiers,” IEEE Transactions on Industrial Informatics, vol. 16, no. 5, pp. 3177-3186, 2019.
9. F. Parralejo, F. J. Aranda, J. A. Paredes, F. J. Alvarez, and J. Morera, “Comparative study of different ble fingerprint reconstruction techniques,” in 2021 International Conference on Indoor Positioning and Indoor Navigation (IPIN). IEEE, 2021, pp. 1-8.
10. M. Zhan and Z. H. Xi, “Indoor location method of wifi/pdr fusion based on extended kalman filter fusion,” in Journal of Physics: Conference Series, vol. 1601, no. 4. IOP Publishing, 2020, p. 042004.
11. J. Xu, H. Chen, K. Qian, E. Dong, M. Sun, C. Wu, L. Zhang, and Z. Yang, “ivr: Integrated vision and radio localization with zero human effort,” Proceedings of the ACM on Interactive, Mobile, Wearable and Ubiquitous Technologies, vol. 3, no. 3, pp. 1-22, 2019.
12. K.-M. Mimoune, I. Ahriz, and J. Guillory, “Evaluation and improvement of localization algorithms based on uwb pozyx system,” in 2019 International Conference on Software, Telecommunications and Computer Networks (SoftCOM). IEEE, 2019, pp. 1-5.
13. W. Chantaweesomboon, C. Suwatthikul, S. Manatrinon, K. Athikulwongse, K. Kaemarungsi, R. Ranron, and P. Suksompong, “On performance study of uwb real time locating system,” in 2016 7th International Conference of Information and Communication Technology for Embedded Systems (IC-ICTES). IEEE, 2016, pp. 19-24.
14. S. Bertuletti, A. Cereatti, M. Caldara, M. Galizzi, and U. Della Croce, “Indoor distance estimated from bluetooth low energy signal strength: Comparison of regression models,” in 2016 IEEE Sensors Applications Symposium (SAS). IEEE, 2016, pp. 1-5.
15. H. Liu, A. Alali, M. Ibrahim, B. B. Cao, N. Meegan, H. Li, M. Gruteser, S. Jain, K. Dana, A. Ashok et al., “Vi-fi: Associating moving subjects across vision and wireless sensors,” in 2022 21st ACM/IEEE International Conference on Information Processing in Sensor Networks (IPSN). IEEE, 2022, pp. 208-219.
16. A. Masullo, T. Burghardt, D. Damen, T. Perrett, and M. Mirmehdi, “Who goes there?exploiting silhouettes and wearable signals for subject identification in multi-person environments,” in Proceedings of the IEEE/CVF International Conference on Computer Vision Workshops, 2019, pp. 0-0.
17. R. Henschel, T. Von Marcard, and B. Rosenhahn, “Accurate long-term multiple people tracking using video and body-worn imus,” IEEE Transactions on Image Processing, vol. 29, pp. 8476-8489, 2020.
18. R. Giuliano, G. C. Cardarilli, C. Cesarini, L. Di Nunzio, F. Fallucchi, R. Fazzolari, F. Mazzenga, M. Re, and A. Vizzarri, “Indoor localization system based on bluetooth low energy for museum applications,” Electronics, vol. 9, no. 6, p. 1055, 2020.
19. M. T. Hoang, B. Yuen, X. Dong, T. Lu, R. Westendorp, and K. Reddy, “Recurrent neural networks for accurate rssi indoor localization,” IEEE Internet of Things Journal, vol. 6, no. 6, pp. 10639-10651, 2019.
20. M. Wang, Y. Liu, D. Su, Y. Liao, L. Shi, J. Xu, and J. V. Miro, “Accurate and real-time 3-d tracking for the following robots by fusing vision and ultrasonar information,” IEEE/ASME Transactions On Mechatronics, vol. 23, no. 3, pp. 997-1006, 2018.
21. R. Wang, F. Zhao, H. Luo, B. Lu, and T. Lu, “Fusion of wi-fi and bluetooth for indoor localization,” in Proceedings of the 1st international workshop on Mobile location-based service, 2011, pp. 63-66.
22. S. Papaioannou, A. Markham, and N. Trigoni, “Tracking people in highly dynamic industrial environments,” IEEE Transactions on mobile computing, vol. 16, no. 8, pp. 2351-2365, 2016.
23. K. Ksia,z⋅ek and K. Grochla, “Aggregation of gps, wlan, and ble localization measurements for mobile devices in simulated environments,” Sensors, vol. 19, no. 7, p. 1694, 2019.
24. D. Zhu, H. Sun, and D. Wu, “Fusion of wireless signal and computer vision for identification and tracking,” in 2021 28th International Conference on Telecommunications (ICT). IEEE, 2021, pp. 1-7.
25. Q. Zhai, S. Ding, X. Li, F. Yang, J. Teng, J. Zhu, D. Xuan, Y. F. Zheng, and W. Zhao, “Vm-tracking: Visual-motion sensing integration for real-time human tracking,” in 2015 IEEE Conference on Computer Communications (INFOCOM). IEEE, 2015, pp. 711-719.
26. Y. Shu, Y. Huang, J. Zhang, P. Coue, P. Cheng, J. Chen, and K. G. Shin, “Gradient-based fingerprinting for indoor localization and tracking,” IEEE Transactions on Industrial Electronics, vol. 63, no. 4, pp. 2424-2433, 2015.
27. S. Cao and H. Wang, “Enabling public cameras to talk to the public,” Proceedings of the ACM on Interactive, Mobile, Wearable and Ubiquitous Technologies, vol. 2, no. 2, pp. 1-20, 2018.
28. H. Li, P. Zhang, S. Al Moubayed, S. N. Patel, and A. P. Sample, “Id-match: A hybrid computer vision and rfid system for recognizing individuals in groups,” in Proceedings of the 2016 CHI Conference on Human Factors in Computing Systems, 2016, pp. 4933-4944.
29. R. Henschel, T. von Marcard, and B. Rosenhahn, “Simultaneous identification and tracking of multiple people using video and imus,” in Proceedings of the IEEE/CVF conference on computer vision and pattern recognition workshops, 2019, pp. 0-0.
30. S. Papaioannou, A. Markham, and N. Trigoni, “Tracking people in highly dynamic industrial environments,” IEEE Transactions on mobile computing, vol. 16, no. 8, pp. 2351-2365, 2016.
31. I. Melekhov, J. Kannala, and E. Rahtu, “Siamese network features for image matching,” in 2016 23rd international conference on pattern recognition (ICPR). IEEE, 2016, pp. 378-383.
32. Y. Zhang, L. Wang, J. Qi, D. Wang, M. Feng, and H. Lu, “Structured siamese network for real-time visual tracking,” in Proceedings of the European conference on computer vision (ECCV), 2018, pp. 351-366.
33. T. Sheng and M. Huber, “Siamese networks for weakly supervised human activity recognition,” in 2019 IEEE International Conference on Systems, Man and Cybernetics (SMC). IEEE, 2019, pp. 4069-4075.
34. J. Mueller and A. Thyagarajan, “Siamese recurrent architectures for learning sentence similarity,” in Proceedings of the AAAI conference on artificial intelligence, vol. 30, no. 1, 2016.
35. Z. Chi and B. Zhang, “A sentence similarity estimation method based on improved siamese network,” Journal of Intelligent Learning Systems and Applications, vol. 10, no. 4, pp. 121-134, 2018.
36. N. Zeghidour, G. Synnaeve, N. Usunier, and E. Dupoux, “Joint learning of speaker and phonetic similarities with siamese networks.” in INTERSPEECH, 2016, pp. 1295-1299.
37. N. Cinefra, “An adaptive indoor positioning system based on bluetooth low energy rssi,” 2014.
38. L. Alsmadi, X. Kong, and K. Sandrasegaran, “Improve indoor positioning accuracy using filtered rssi and beacon weight approach in ibeacon network,” in 2019 19th International Symposium on Communications and Information Technologies (ISCIT). IEEE, 2019, pp. 42-46.
39. A. Ozer and E. John, “Improving the accuracy of bluetooth low energy indoor positioning system using kalman filtering,” in 2016 International Conference on Computational Science and Computational Intelligence (CSCI). IEEE, 2016, pp. 180-185.
40. J. Redmon and A. Farhadi, “Yolov3: An incremental improvement,” arXiv preprint arXiv:1804.02767, 2018.
41. A. Bewley, Z. Ge, L. Ott, F. Ramos, and B. Upcroft, “Simple online and real-time tracking,” in 2016 IEEE international conference on image processing (ICIP). IEEE, 2016, pp. 3464-3468.
42. M. Ahmad, I. Ahmed, and G. Jeon, “An iot-enabled real-time overhead view person detection system based on cascade-rcnn and transfer learning,” Journal of Real-Time Image Processing, vol. 18, no. 4, pp. 1129-1139, 2021.
43. H. Zhu, P. Tang, J. Park, S. Park, and A. Yuille, “Robustness of object recognition under extreme occlusion in humans and computational models,” arXiv preprint arXiv:1905.04598, 2019.
44. D. Oosterlinck, D. F. Benoit, P. Baecke, and N. Van de Weghe, “Bluetooth tracking of humans in an indoor environment: An application to shopping mall visits,” Applied Geography, vol. 78, pp. 55-65, 2017.
45. P. Centorrino, A. Corbetta, E. Cristiani, and E. Onofri, “Managing crowded museums: Visitors flow measurement, analysis, modeling, and optimization,” Journal of Computational Science, vol. 53, p. 101357, 2021.

What is claimed is:

1. A multimodal indoor positioning system comprising:
one or more Bluetooth low energy beacons;
one or more smartphones, wherein the smartphone captures one or more Bluetooth low energy signals from the one or more Bluetooth low energy beacons, wherein the one or more Bluetooth low energy signals comprises a relative signal strength indicator signal, wherein the smartphone generates a fingerprint and a location estimate from the relative signal strength indicator signal;
one or more cameras, wherein the one or more cameras capture 2D video frames; and
one or more edge devices, wherein the one or more edge devices are in electronic communication with the one or more cameras, wherein the one or more edge devices are in electronic communication with the one or more smartphones, wherein the one or more edge devices are in electronic communication with the one or more Bluetooth low energy beacons, wherein the one or more edge devices receive the fingerprint and the location estimate from the one or more smartphones, wherein the one or more edge devices receive the 2D video frames from the one or more cameras, wherein the edge device generates 2D position coordinates from the 2D video frames; and wherein the one or more edge devices assigns a tracklet-ID to each smartphone in the 2D video frames.

2. The multimodal indoor positioning system of claim 1, wherein the edge device performs SORT Tracking and YOLO object detection.

3. The multimodal indoor positioning system of claim 1, wherein the one or more edge devices receive the fingerprint and the location estimate from the one or more smartphones over MQ Telemetry Transport.

4. A non-transitory computer readable medium comprising instructions which, when implemented by one or more computers, causes the one or more computers to:
receive a Bluetooth low energy signal from Bluetooth low energy beacon, wherein the Bluetooth low energy signal comprises a relative signal strength indicator signal;
generate a fingerprint and a location estimate from the relative signal strength indicator signal;
capture 2D video frames from the one or more cameras;
generate tracklet IDs and 2D coordinates for one or more people in the 2D video frames; and
display the fingerprint and the location estimate.

5. The non-transitory computer readable medium of claim 4, wherein the Object Localization Accuracy is displayed on a screen.

6. The non-transitory computer readable medium of claim 4, wherein the generated tracking IDs comprise a formula, TR=tr₁, tr₂, . . . , trₘ, wherein at each timestep tⱼ in an indoor space.

7. The non-transitory computer readable medium of claim 4, wherein the indoor space, I, comprises a p×q grid cell configuration, wherein each grid cell is a 1 meter by 1 meter.

8. The non-transitory computer readable medium of claim 4, wherein new tracking IDs are generated due to ID switching or occlusions.

9. The non-transitory computer readable medium of claim 4, wherein the generate a fingerprint and a location estimate from the relative signal strength indicator signal comprises a machine learning algorithm and a random forest-based classification model, wherein the random-forest-based classification model is trained to detect a grid location of each of the devices at each time period.

10. The non-transitory computer readable medium of claim 4, wherein the instructions provide an Object Localization Accuracy comprising a fraction of cells for which the predicted grid cell matches the ground truth grid cell of the object, wherein the Object Localization Accuracy comprises a formula:
$$OLA = \frac{{\sum }_{j = 0}^{n} {a}_{j}}{{\sum }_{j = 0}^{n} {I}_{j}} ,$$
wherein aⱼ is the total number of accurately predicted grid cells over the trajectory for object j, Iⱼ is the total number of grid cells for trajectories for object j during the scenario, and n is the total number objects.

11. The non-transitory computer readable medium of claim 4, wherein the instructions provide an Object Localization Error, wherein the Object Localization Error is the average distance between the actual and predicted location for each object throughout the object's trajectory, and wherein the Object Localization Error comprises the formula:
$$OLE = \frac{{\sum }_{i = 0}^{t} {\sum }_{j = 0}^{n} {A}_{i , j} - {P}_{i , j}}{t \times n} ,$$
wherein t represents the numbers of time-steps in the trajectory of the object, n is the total number of objects, A_{i,j}, are actual coordinates of an object j at a time i, and P_{i,j} are predicted coordinates of the object j at the time i.

12. The non-transitory computer readable medium of claim 4, wherein the generate a fingerprint and a location estimate from the relative signal strength indicator signal comprises a Siamese network.

13. The non-transitory computer readable medium of claim 4, wherein the generate a fingerprint and a location estimate from the relative signal strength indicator signal comprises a machine learning algorithm.

14. The non-transitory computer readable medium of claim 13, wherein the machine learning algorithm comprising a random forest-based classification.

15. The non-transitory computer readable medium of claim 7, wherein the grid location comprises p×q grid cells, wherein objects, sᵢ, carrying device d, is present at time tⱼ, and wherein a center of the grid box location comprises a formula: lb_{i,j}=(x_{lbi,j}, y_{lbi,j}), wherein Bluetooth device dᵢ, at time tⱼ.

16. The non-transitory computer readable medium of claim 10, wherein the instructions provide an average Object Localization Accuracy from about 92% to about 96%.

17. The non-transitory computer readable medium of claim 11, wherein the instructions provide an average Object Localization Error from about 37% to about 43%.
